(19) United States
(12) Patent Application Publication
(10) Pub. No.: US 2008/0050618 A1
(43) Pub. Date: Feb. 28, 2008

(54) PROTON EXCHANGE MEMBRANE FUEL CELL BIPOLAR PLATE

(75) Inventors: Fumio TANNO, Okazaki-shi (JP); Naoki SHIJI, Okazaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NISSHINBO INDUSTRIES, INC., Tokyo (JP)

(21) Appl. No.: 11/843,179

(22) Filed: Aug. 22, 2007

(30) Foreign Application Priority Data
Aug. 24, 2006 (JP) 2006-228062

(51) Int. Cl. H01M 8/00

(52) U.S. Cl. 429/12

(57) ABSTRACT

A proton exchange membrane fuel cell bipolar plate molded from a composition that includes a graphite powder, a thermosetting resin and an internal mold release agent has specific surface characteristics which endow the bipolar plate with a high hydrophilicity that enables water formed during power generation by the fuel cell to be easily removed. The bipolar plate also has a low contact resistance with electrodes in the fuel cell, and the shapes of flow channels on the bipolar plate remain intact.

### CROSS-REFERENCE TO RELATED APPLICATION

This non-provisional application claims priority under 35 U.S.C. S119(a) on Patent Application No. 2006-228062 filed in Japan on Aug. 24, 2006, the entire contents of which are hereby incorporated by reference.

### BACKGROUND OF THE INVENTION

1. Field of the Invention

The present invention relates to a proton exchange membrane fuel cell bipolar plate.

2. Prior Art

Fuel cells are devices which, when supplied with a fuel such as hydrogen and with atmospheric oxygen, cause the fuel and oxygen to react electrochemically, producing water and directly generating electricity. Because fuel cells are capable of achieving a high fuel-to-energy conversion efficiency and have an excellent environmental adaptability, they are being developed for a variety of applications, including small-scale local power generation, household power generation, simple power supplies for isolated facilities such as campgrounds, mobile power supplies such as for automobiles and small boats, and power supplies for satellites and space development.

Such fuel cells, and particularly proton exchange membrane fuel cells, are built in the form of modules composed of a stack of at least several tens of unit cells. Each unit cell has a pair of plate-like bipolar plates with raised areas on either side thereof that define a plurality of channels for the flow of gases such as hydrogen and oxygen. Disposed between the pair of bipolar plates in the unit cell are a solid polymer electrolyte membrane and gas diffusing electrodes made of carbon paper.

One role of the fuel cell bipolar plates is to confer each unit cell with electrical conductivity. In addition, the bipolar plates provide flow channels for the supply of fuel and air (oxygen) to the unit cells and also serve as separating boundary membranes. Characteristics required of the bipolar plates thus include a high electrical conductivity, a high gas impermeability, electrochemical stability and hydrophilicity.

However, the water produced by the reaction between the gases during power generation by the fuel cell is known to have a large effect on the fuel cell characteristics. Of the properties desired in a bipolar plate, the ability to rapidly remove water that has formed during power generation is the most important. Because this water-removing ability depends on the hydrophilicity of the bipolar plate, there exists a need to enhance the hydrophilicity.

Methods for enhancing the hydrophilicity of the bipolar plate include (1) coating the surface of the bipolar plate with a hydrophilic inorganic powder (JP-A 1983-150278), (2) bonding a sheet of hydrophilic inorganic fibers and a sheet of organic fibers to the surface of the bipolar plate (JP-A 1988-110555, JP-A 2001-7637), (3) incorporating both hydrophilic inorganic fibers and powder and also organic fibers and powder into the interior of the bipolar plate (JP-A 1998-3931), (4) dipping into acid the portions of the bipolar plate that will come into contact with electrodes (JP-A 1999-297388), (5) surface treatment in multiple stages using a wet blasting machine (JP-A 2006-19252), (6) surface treatment with the sealing areas in a masked state so as to hold down the contact resistance of the gas flow channels and to ensure the sealability of the sealing areas (JP-A 2003-132913), and (7) surface treating the gas flow channels with an alumina abrasive grain so as to increase the hydrophilicity of the gas flow channels and to keep the contact resistance low (JP-A 2005-197222).

However, in above method (1), the hydrophilic layer composed of an inorganic powder that has been coated onto the bipolar plate surface is subject to peeling or wear during fuel cell assembly, lowering the hydrophilicity of the bipolar plate.

In method (2), the sheets on the bipolar plate surface may detach or may crease on the flow channel side, lowering the hydrophilicity of the bipolar plate and its ability to remove water.

In method (3), the incorporation of a large amount of inorganic fibers or organic fibers to enhance the hydrophilic properties gives rise to a new problem: a decline in the electrical conductivity.

In method (4), acidic solution remaining in the bipolar plate may leach out during fuel cell operation or may dissolve resin within the bipolar plate.

In method (5), because it is necessary to carry out blasting in stages, there are a large number of stages, which increases the production costs. Moreover, the initial stage of blasting treatment in which large-diameter particles are used may deform the flow channels, lowering the ability of the fuel cell to generate electricity.

In methods (6) and (7), blasting treatment is used to hold down the contact resistance of the gas flow channels. However, because such treatment roughens the surfaces of the sealing grooves, these grooves must be masked to prevent a loss of sealability, thus adding an additional degree of complexity to the process.

### SUMMARY OF THE INVENTION

It is therefore an object of the invention to provide a proton exchange membrane fuel cell bipolar plate which has a high hydrophilicity that enables water which forms as a result of power generation by the fuel cell to be easily removed, which exhibits a low contact resistance, and in which the shapes of the flow channels have been kept intact.

We have discovered that when the surface of a proton exchange membrane fuel cell bipolar plate obtained by shaping a composition containing graphite powder, a thermosetting resin and an internal mold release agent is adjusted to an arithmetic mean roughness Ra in a range of 0.27 to 0.42 μm and a maximum height roughness Rz in a range of 2.0 to 8.0 μm by blasting treatment, the bipolar plate can be made to exhibit a high hydrophilicity and a low contact resistance. We have also found that, during bipolar plate surface treatment, by carrying out blasting treatment using an abrasive grain having an average particle size within a given range, a high hydrophilicity can be imparted while keeping intact the shapes of the flow channels and, even when the gas flow channels and the sealing grooves are treated at the same time without first masking the sealing areas, the contact resistance can be held to a low level without incurring a loss of sealability.

Accordingly, the invention provides a proton exchange membrane fuel cell bipolar plate which is obtained by shaping a composition that includes a graphite powder, a thermosetting resin and an internal mold release agent, then roughening a surface of the bipolar plate by blasting treatment using an abrasive grain, and the surface has an arithmetic mean roughness Ra of from 0.27 to 0.42 μm and a maximum height roughness Rz of from 2.0 to 8.0 μm, and preferably from 2.0 to 2.51 μm.

Preferably, the bipolar plate has a wetting tension of from 54 to 70 mN/m according to JIS K6768, a static contact angle of from 64 to 70°, and a contact resistance of from 4 to 7 mΩcm².

The abrasive grain has a mean particle diameter (d=50) of preferably from 6 to 30 μm, and more preferably from 6 to 20 μm. The grain is typically made of one or more material selected from the group consisting of alumina, silicon carbide, zirconia, glass, nylon and stainless steel.

The fuel cell bipolar plate composition preferably includes from 10 to 30 parts by weight of the thermosetting resin and from 0.1 to 1.5 parts by weight of the internal mold release agent per 100 parts by weight of the graphite powder.

The graphite powder in the fuel cell bipolar plate typically has a mean particle diameter (d=501) of from 20 to 70 μm.

The proton exchange membrane fuel cell bipolar plate of the invention, by having at the surface thereof an arithmetic mean roughness Ra of from 0.27 to 0.42 μm and a maximum height roughness Rz of from 2.0 to 8.0 μm, is endowed with a high hydrophilicity which enables water formed during power generation by the fuel cell to be easily removed. Moreover, because the inventive bipolar plate possesses the above surface characteristics, it has a good adhesion with gasket, making it possible to minimize gas leaks, in addition to which contact resistance with the electrodes can be held to a low level. Fuel cells equipped with the bipolar plates of the invention are thus capable of maintaining a stable power generating efficiency over an extended period of time.

In addition, because the bipolar plate surface is roughened by blasting treatment using an abrasive grain having a mean particle diameter within a specific range, the surface can easily be adjusted to Ra and Rz values within the above-indicated ranges. As a result, the wetting tension of the surface can easily be modified to a range of about 54 to about 70 mN/m, and the contact angle can easily be modified to a range of about 64 to about 70°. When such roughening is carried out, even if the entire surface of the bipolar plate is subjected to blasting treatment without masking the sealing grooves of the bipolar plate, the desired electrical conductivity can be achieved with no loss in the sealability of the sealing areas.

### DETAILED DESCRIPTION OF THE INVENTION

As noted above, the proton exchange membrane fuel cell bipolar plate of the invention is obtained by shaping a composition which includes a graphite powder, a thermosetting resin and an internal mold release agent, then roughening a surface of the bipolar plate by blasting treatment using an abrasive grain, and is characterized by having a surface with an arithmetic mean roughness Ra of from 0.27 to 0.42 μm and a maximum height roughness Rz of from 2.0 to 8.0 μm.

At an arithmetic mean roughness Ra of less than 0.27 μm and a maximum height roughness Rz of less than 2.0 μm, the surface tension of water is maintained, making it easier for water that has formed on the bipolar plate surface to coalesce within the flow channels, as a result of which the water is more difficult to remove. Moreover, the presence of a thermosetting resin layer between the graphite particles at the surface layer of the bipolar plate diminishes the surface area of contact between the electrodes and the graphite, making an increase in the contact resistance very likely.

On the other hand, at an arithmetic mean roughness Ra of more than 0.42 μm or a maximum height roughness Rz of more than 8.0 μm, adhesion between the bipolar plate and gasket worsens, as a result of which gas leakage may arise.

To further increase the hydrophilicity-enhancing effect and the contact resistance-lowering effect of the fuel cell bipolar plate, it is preferable for the surface of the bipolar plate to have an arithmetic mean roughness Ra of from 0.27 to 0.35 μm and a maximum height roughness Rz of preferably from 2.0 to 2.51 μm.

Also, in the fuel cell bipolar plate of the invention, because the surface characteristics are adjusted within the foregoing ranges, it is preferable for the wetting tension to be from 54 to 70 mN/m, for the static contact angle to be from 64 to 70°, and for the contact resistance to be from 4 to 7 mΩcm², and especially from 4 to 6.6 mΩcm².

Fuel cells equipped with the fuel cell bipolar plates of the invention will thus have an acceptable hydrophilicity and electrical conductivity, enabling the cells to maintain a stable power generating efficiency over an extended period of time.

Illustrative, non-limiting, examples of graphite materials that may be used in the invention include natural graphite, synthetic graphite obtained by firing needle coke, synthetic graphite obtained by firing lump coke, graphite obtained by grinding electrodes to a powder, coal pitch, petroleum pitch, coke, activated carbon, glassy carbon, acetylene black and Ketjenblack. Any one or combination of two or more thereof may be used.

The above graphite material has a mean particle diameter (d=50) which, while not subject to any particular limitation, is preferably from 20 to 70 μm, more preferably from 30 to 60 μm, and even more preferably from 40 to 50 μm.

At a mean particle diameter of less than 20 μm, the thermosetting resin will tend to coat the surface of the graphite, lowering the surface area of contact between graphite particles. As a result, it is very likely that the electrical conductivity of the bipolar plate proper will worsen. On the other hand, at a mean particle diameter of more than 70 μm, the thermosetting resin will tend to infiltrate into the gaps between the graphite particles, lowering the surface area of contact between graphite particles. As a result, it is very likely in such cases as well that the electrical conductivity of the bipolar plate proper will worsen.

That is, when the graphite material has a mean particle diameter outside a range of 20 to 70 μm, a layer of thermosetting resin tends to form at the surface of the graphite particles or in the gaps between the particles. In either case, there is a high possibility that such a situation will worsen the electrical conductivity of the bipolar plate proper.

A bipolar plate obtained by shaping a composition which includes graphite powder adjusted to a mean particle diameter (d=50) in a range of from 20 to 70 μm will generally have, at the surface layer thereof, a layer of thermosetting resin present between the graphite particles. However, by adjusting the surface roughness of the bipolar plate to the arithmetic mean roughness Ra and the maximum height roughness Rz specifically mentioned earlier, this thermosetting resin layer is removed, thus making it possible to obtain a bipolar plate having both an excellent hydrophilicity and a low contact resistance.

To further increase the hydrophilicity-enhancing effect and the contact resistance-lowering effect in proton exchange membrane fuel cell bipolar plates, it is more preferable for the graphite powder to have a mean particle diameter (d 50) of from 30 to 60 μm, a content of fine grains with a particle diameter below 5 μm of 5% or less and a content of coarse grains with a particle diameter above 100 μm of 3% or less. It is even more preferable for the graphite powder to have a mean particle diameter (d=50) of from 40 to 50 μm, a content of fine grains with a particle diameter below 5 μm of 3% or less and a content of coarse grains with a particle diameter above 100 μm of 1% or less.

The mean particle diameter (d=50) is a measured value obtained with a particle size analyzer manufactured by Nikkiso Co., Ltd.

The thermosetting resin for working the invention is not subject to any particular limitation. Use may be made of any of the various types of thermosetting resins from which fuel cell bipolar plates have hitherto been molded or formed. Illustrative examples include any one or combination of two or more of the following: resole-type phenolic resins, epoxy resins, polyester resins, urea resins, melamine resins, silicone resins, vinyl ester resins, diallyl phthalate resins and benzoxazine resins. Of these, benzoxazine resins, epoxy resins and resole-type phenolic resins are preferred on account of their excellent heat resistance and mechanical strength.

The internal mold release agent may be any internal mold release agent that has hitherto been used in the molding or forming of bipolar plates without limitation. Illustrative examples include stearic acid-based waxes, amide-based waxes, montanic acid-based waxes, carnauba wax and polyethylene waxes. These may be used singly or as combinations of two or more thereof.

The composition which includes graphite powder, a thermosetting resin and an internal mold release agent (which composition is referred to hereinafter as the “fuel cell bipolar plate-forming composition”) has a thermosetting resin content that, while not subject to any particular limitation, is preferably from 10 to 30 parts by weight, and more preferably from 15 to 25 parts by weight, per 100 parts by weight of the graphite powder. At a thermosetting resin content of less than 10 parts by weight, fuel cell bipolar plates made from the composition may be subject to gas leakage and may have a decreased strength. On the other hand, at more than 30 parts by weight, such bipolar plates may have a lower electrical conductivity.

The fuel cell bipolar plate-forming composition has an internal mold release agent content which, while not subject to any particular limitation, is preferably from 0.1 to 1.5 parts by weight, and more preferably from 0.3 to 1.0 part by weight, per 100 parts by weight of the graphite powder. At an internal mold release agent content below 0.1 part by weight, mold release may be poor, whereas a content of more than 1.5 parts by weight may interfere with curing of the thermosetting resin or cause other problems.

The proton exchange membrane fuel cell bipolar plate of the invention is obtained by shaping the above-described fuel cell bipolar plate-forming composition. Any of various conventional methods for preparing the composition and shaping the bipolar plate may be used without particular limitation.

For example, preparation of the composition may be carried out by mixing in any order and in the specified proportions the above-described thermosetting resin, graphite powder and internal mold release agent. Examples of mixers that may be used for this purpose include planetary mixers, ribbon blenders, Loedige mixers, Henschel mixers, rocking mixers and Nauta mixers.

The method for shaping the bipolar plate also is not subject to any particular limitation. For example, use can be made of injection molding, transfer molding, compression molding, or extrusion. Of these, compression molding is preferred on account of the excellent precision and mechanical strength of the molded bipolar plates thereby obtained.

The surface of the bipolar plate obtained by the above molding or forming method is roughened by blasting treatment using an abrasive grain. The arithmetic mean roughness Ra and maximum height roughness Rz of the bipolar plate surface may be adjusted thereby within the above-indicated ranges.

The abrasive grain used in blasting treatment has a mean particle diameter (d=50) of preferably from 6 to 30 μm, more preferably from 6 to 25 μm, and even more preferably from 6 to 20 μm.

If the abrasive grain has a mean particle diameter of less than 6 μm, treatment to an arithmetic mean roughness Ra of 0.3 μm or more will be difficult, as a result of which resin will tend to remain on the surface layer. At a mean particle diameter of more than 30 μm, the particle size is too coarse, as a result of which some of the abrasive grain will tend to stick to and remain on the bipolar plate surface.

Moreover, by using an abrasive grain having a mean particle diameter in the above range, even when both the gas flow channels and the sealing grooves are subjected to blasting treatment at the same time without first masking the sealing grooves, no loss in the sealability of the sealing grooves occurs, making it possible to keep the contact resistance low.

That is, by subjecting the entire surface of the bipolar plate to blasting treatment using abrasive grain having a mean particle diameter (d=50) of from 6 to 30 μm and thereby adjusting the bipolar plate surface to an arithmetic mean roughness Ra of from 0.27 to 0.42 μm and a maximum height roughness Rz of from 2.0 to 8.0 μm, fine roughness form on the surfaces of the flow channels, breaking up the balance in the surface tension of water and thus enhancing the hydrophilicity. Moreover, thermosetting resin at the surface layer of the bipolar plate is removed, thus increasing the surface area of contact with adjoining electrodes and making it possible to lower the contact resistance. Moreover, even in the sealing areas, because the maximum height roughness Rz is in a range of from 2.0 to 8.0 μm, a good sealability can be exhibited.

No particular limitation is imposed on the method of blasting treatment, so long as it is capable of roughening the bipolar plate surface. For example, use may be made of shot blasting, air blasting or wet blasting. Of these, air blasting and wet blasting are preferred. Wet blasting is most preferable because little abrasive grain remains on the bipolar plate surface following treatment.

Abrasive materials that may be used in blasting treatment are exemplified by alumina, silicon carbide, zirconia, glass, nylon and stainless steel. These may be used singly or as combinations of two or more thereof.

Because the proton exchange membrane fuel cell bipolar plate of the invention described above has a very high hydrophilicity and the contact resistance has been held low, fuel cells equipped with such bipolar plates are able to maintain a stable power generating efficiency over a long period of time.

A proton exchange membrane fuel cell is generally composed of a stack of many unit cells, each of which is constructed of a solid polymer membrane disposed between a pair of electrodes that are in turn sandwiched between a pair of bipolar plates which form channels for the supply and removal of gases. The proton exchange membrane fuel cell bipolar plate of the invention may be used as some or all of the plurality of bipolar plates in the fuel cell.

### EXAMPLES

The following Examples of the invention and Comparative Examples are provided to illustrate the invention and are not intended to limit the scope thereof. Mean particle diameters given below are values measured using a particle size analyzer manufactured by Nikkiso Co., Ltd.

### Examples 1 to 4

### Comparative Examples 1 to 8

In each example, a fuel cell bipolar plate-forming composition was prepared by charging a Henschel mixer with 100 parts by weight of a synthetic graphite powder having the mean particle diameter (d=50) shown in Table 1 and obtained by firing needle coke, 24 parts by weight of phenolic resin as the thermosetting resin and 0.3 part by weight of carnauba wax as the internal mold release agent, then mixing for 3 minutes at 1,500 rpm.

The resulting composition was poured into a 300×300 mm mold and compression molded at a mold temperature of 180° C., a molding pressure of 29.4 MPa and a molding time of 2 minutes to form a molded body. The molded body was then subjected to the surface treatment indicated below, thereby giving a fuel cell bipolar plate having the surface roughness characteristics shown in Table 1.

Surface Treatment Method in Examples 1 to 3 and Comparative Examples 1 and 4:

The molded body was surface treated by wet blasting with the alumina abrasive grain shown in Table 1 at a nozzle pressure of 0.25 MPa. The sealing grooves were not masked during surface treatment.

Surface Treatment Method in Example 4 and Comparative Examples 2, 3 and 5 to 8:

The molded body was surface treated by air blasting with the alumina abrasive grain shown in Table 1 at a nozzle pressure of 0.25 MPa. The sealing grooves were not masked during surface treatment.

The fuel cell bipolar plate samples obtained in the above examples and comparative examples were measured and evaluated for surface roughness in terms of arithmetic mean roughness Ra, maximum height roughness Rz, mean spacing of profile irregularities RSm and mean spacing of local peaks S, and also for resistivity, contact resistance, wetting tension and contact angle. The results are shown in Table 1. Measurement and evaluation were carried out by the following methods.

1. Surface Characteristics (Ra, Rz, RSm, S):

Measured using a surface roughness tester (Surfcom 14000, manufactured by Tokyo Seimitsu Co., Ltd.) having a probe tip diameter of 5 μm.

2. Resistivity:

Measured based on the methods for testing the conductor resistance and volume resistivity of metallic resistance materials described in JIS C2525.

3. Contact Resistance:

(1) Carbon Paper+Bipolar plate Sample:

Two sheets of the respective bipolar plate samples obtained as described above were stacked together, and carbon paper (TGP-H060, produced by Toray Industries, Inc.) was placed above and below the stacked bipolar plate samples. Copper electrodes were placed above and below the resulting stack. A surface pressure of 1 MPa was then applied vertically to the entire stack, and the voltage was measured by the four-point probe method.

(2) Carbon Paper:

Copper electrodes were placed above and below a sheet of carbon paper, following which a surface pressure of 1 MPa was applied vertically thereto and the voltage was measured by the four-point probe method.

(3) Method for Calculating Contact Resistance:

The voltage drop between the bipolar plate samples and the carbon paper was determined from the respective voltages obtained in (1) and (2) above, and the contact resistance was computed as follows.
Contact Resistance=(voltage drop×surface area of contact)/current
4. Wettability

Measured based on JIS K6768 (Plastics—Film and sheeting—Determination of wetting tension).

5. Contact Angle

Measured using a contact angle meter (model CA-DT A, manufactured by Kyowa Interface Science Co., Ltd.).

TABLE 1

| | | Graphite | Abrasive | | | | | | | | |
|---|---|---|---|---|---|---|---|---|---|---|---|
| | | powder | grain | | | | | | | | |
| | | particle | particle | | | | | | Contact | Wetting | Contact |
| | | diameter | diameter | Ra | Rz | RSm | S | Resistivity | resistance | tension | angle |
| | | (μm) | (μm) | (μm) | (μm) | (μm) | (μm) | (mΩcm) | (mΩcm²) | (mN/m) | (°) |
| Example | 1 | 30 | 6 | 0.35 | 2.45 | 111.87 | 23.72 | 6.2 | 6.6 | 54 | 70 |
| | 2 | 50 | 6 | 0.39 | 2.51 | 107.56 | 21.08 | 5.8 | 6.0 | 54 | 70 |
| | 3 | 70 | 6 | 0.35 | 2.47 | 121.32 | 23.75 | 5.3 | 5.8 | 67 | 64 |
| | 4 | 70 | 6 | 0.42 | 2.45 | 120.21 | 24.97 | 5.3 | 5.4 | 54 | 70 |
| Comparative | 1 | 10 | 3 | 0.18 | 1.22 | 65.21 | 16.32 | 12.5 | 35.2 | 34 | 124 |
| Example | 2 | 10 | 100 | 4.46 | 26.34 | 228.57 | 69.70 | 12.5 | 12.4 | 34 | 110 |
| | 3 | 10 | 200 | 8.25 | 60.22 | 308.42 | 80.22 | 12.4 | 25.6 | 34 | 110 |
| | 4 | 50 | 3 | 0.12 | 1.16 | 59.46 | 15.40 | 6.5 | 38.4 | 36 | 108 |
| | 5 | 50 | 100 | 4.32 | 28.32 | 185.52 | 79.46 | 6.5 | 12.1 | 36 | 110 |
| | 6 | 100 | 40 | 0.24 | 2.21 | 108.93 | 24.52 | 6.5 | 25.6 | 34 | 108 |
| | 7 | 100 | 100 | 3.41 | 18.55 | 155.47 | 72.44 | 10.2 | 25.1 | 36 | 110 |
| | 8 | 100 | 100 | 7.56 | 51.24 | 251.47 | 88.46 | 10.2 | 32.2 | 36 | 110 |

Ra: Arithmetic mean roughness (JIS B0601 2001)
Rz: Maximum height roughness (JIS B0601 2001)
RSm: Mean spacing of profile irregularities (JIS B0601 2001)
S: Mean spacing of local peaks (JIS B0601 1994)

As is apparent from Table 1, because the fuel cell bipolar plates obtained in the above examples according to the invention were made using a carbon powder having a mean particle diameter of from 20 to 70 μm and the bipolar plate surface had an arithmetic mean roughness Ra of from 0.27 to 0.42 μm and a maximum height roughness Rz of from 2.0 to 8.0 μm, in each case the contact resistance was held to a lower level than the fuel cell bipolar plates obtained in the comparative examples, the contact angle was lower, and the wetting tension was higher, resulting in a better hydrophilicity.

Japanese Patent Application No. 2006-228062 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A proton exchange membrane fuel cell bipolar plate which is obtained by shaping a composition comprising a graphite powder, a thermosetting resin and an internal mold release agent, then roughening a surface of the bipolar plate by blasting treatment using an abrasive grain,
said surface having an arithmetic mean roughness Ra of from 0.27 to 0.42 μm and a maximum height roughness Rz of from 2.0 to 8.0 μm.

2. The fuel cell bipolar plate of claim 1 which has a wetting tension of from 54 to 70 mN/m according to JIS K6768, a static contact angle of from 64 to 70°, and a contact resistance of from 4 to 7 mΩcm².

3. The fuel cell bipolar plate of claim 1, wherein said surface has a maximum height roughness Rz of from 2.0 to 2.51 μm.

4. The fuel cell bipolar plate of claim 3, wherein said abrasive grain has a mean particle diameter (d=50) of from 6 to 30 μm.

5. The fuel cell bipolar plate of claim 3, wherein said abrasive grain has a mean particle diameter (d=50) of from 6 to 20 μm.

6. The fuel cell bipolar plate of claim 3, wherein said abrasive grain is made of one or more material selected from the group consisting of alumina, silicon carbide, zirconia, glass, nylon and stainless steel.

7. The fuel cell bipolar plate of claim 1, wherein said composition includes from 10 to 30 parts by weight of the thermosetting resin and from 0.1 to 1.5 parts by weight of the internal mold release agent per 100 parts by weight of the graphite powder.

8. The fuel cell bipolar plate of claim 1, wherein said graphite powder has a mean particle diameter (d=50) of from 20 to 70 μm.
